(19) United States
(12) Patent Application Publication
(10) Pub. No.: US 2010/0133833 A1
(43) Pub. Date: Jun. 3, 2010

(54) ELECTRICAL POWER GENERATION FOR DOWNHOLE EXPLORATION OR PRODUCTION DEVICES

(75) Inventor: Brock A. Williams, Sugar Land, TX (US)

Correspondence Address: CAROL WILSON;BP AMERICA INC., MAIL CODE 5 EAST, 4101 WINFIELD ROAD, WARRENVILLE, IL, 60555, US

(73) Assignee: BP CORPORATION NORTH AMERICA INC., Warrenville, IL (US)

(21) Appl. No.: 12/603,914

(22) Filed: Oct. 22, 2009

Related U.S. Application Data
(60) Provisional application No. 61/108,471, filed on Oct. 24, 2008.

(51) Int. Cl. H02P 9/04; G01V 3/00; F03G 7/08

(52) U.S. Cl. 290/50; 340/856.3; 290/1 R

(57) ABSTRACT

A method and system for generating electrical power in a downhole well is disclosed. In an embodiment, the electrical power is generated by the rotational motion of a downhole tool and enables the charging or recharging of batteries in downhole sensors or sensors in other remote locations, such as in a water column. Magnets are arranged in a manner to provide a rotating magnetic field and are then coupled or attached to the rod/rotor assembly in close proximity to the rotating tool. By utilizing the rotational energy of a tool that uses or causes rotational motion during operations in conjunction with the windings of an electrical conductor and power conditioning circuitry, the rotation of the magnets induces an electrical current in the electrical conductor and power conditioning circuitry that can then be used to directly charge a tool and/or to instead charge or recharge the batteries that power the downhole or below-surface sensor.

### RELATED APPLICATIONS

This utility application claims priority to U.S. provisional application No. 61/108,471, which was filed Oct. 24, 2008, and which is entitled Electrical Power Generation for Battery Powered Exploration or Production Devices; that provisional application is still pending.

### BACKGROUND

The control of oil and gas exploration and production wells remains an on-going concern of the petroleum industry due to the enormous monetary expense involved in exploration and production operations, as well as the risks associated with environmental and safety issues. Production well control has also become especially important and more complex in view of the industry wide recognition that wells having multiple branches will be increasingly commonplace.

Additionally, measurements of drilling parameters and logs to measure properties of the surrounding strata are common while drilling wells. These measurements are taken by various instruments mounted within the drill string. Furthermore, measurements concerning the direction of the drill bit have become particularly important in recent years with the growth in number of directional and horizontal wells. Moreover, modern petroleum drilling and production operations include a great demand for a significant quantity and quality of information relating to parameters and conditions downhole and below water. Such information downhole typically includes characteristics of the earth formations traversed by the wellbore, along with data relating to the size and configuration of the borehole itself. The collection of information relating to conditions downhole is commonly is referred to as “logging”.

In this connection, well-logging is the measurement of characteristics of different earth formations traversed by a borehole, usually an oil or gas well using one or more measuring instruments or tools. The tools are typically stacked in a tool string attached to a logging cable which supports the tool string, provides power to the tool or tools and in the past has also provided a communication medium for the transmission of data from the tool or tools to data acquisition and processing equipment on the surface.

Modern well drilling techniques further involve the use of several different measurement and telemetry systems to provide petrophysical data and data regarding drilling mechanics during the drilling process; many of these are wireless/cableless. Designs for measuring conditions downhole including the movement and location of the drilling assembly contemporaneously with the drilling of the well have come to be known as measurement-while-drilling (“MWD”) techniques. In such techniques, data is acquired by sensors located in the drill string near the bit and either stored in downhole memory components or transmitted to the surface using telemetry devices. In the MWD tools, data is acquired by sensors located within the drill string near the bit.

The data transmitted in a well-logging digital telemetry system is typically first transmitted over a BUS within the tool string to a downhole modem that then uses the data to modulate a carrier signal that is suitable for transmission to the surface. This data is then transmitted to the surface using a telemetry means, such as mud flow telemetry devices.

In typical prior art operations, the data is either transmitted to the surface over the logging cable, or via a wireless telemetry system that is powered by one or more batteries. Unfortunately, the life and limitations of the batteries often dictate the frequency and/or duration of the signals that can be transmitted. There is therefore a long-felt need to eliminate the operational constraints of wireless telemetry and sensor caused by battery limitations.

This invention discloses a method and system of internal power generation that can be used to generate electricity to power the various devices, including but not limited to downhole and subsurface sensors used in exploration and production operations.

### BRIEF DESCRIPTION OF THE DRAWINGS

FIG. 1 is a pictorial representation of a a cross-sectional view of an embodiment of the invention being used in a down hole environment.

### DETAILED DESCRIPTION

A method and system for generating electrical power in a downhole well is disclosed. In an embodiment, the electrical power is generated by the rotational motion of a downhole tool, and enables the recharging of batteries downhole sensors or sensors in other remote locations, such as in a water column, by utilizing the rotational energy of a tool which undergoes rotational motion during operations in conjunction with the windings of an electrical conductor and power conditioning circuitry. In contrast in current practice, the prior art systems require that the sensor must be retrieved and the batteries changed out once the battery power is depleted. This invention also enables more frequent sensor readings and transmissions due to the eliminated battery constraints.

In an aspect, the method and system for generating electrical power is practiced in a virtually in any setting or environment where rotational mechanical energy is generated during normal operations of a device or system and where sensors or other apparatus that are related to or a part the mechanical operations are powered by batteries which can been charged or recharged.

Alternatively and in addition to the foregoing, the mechanical energy can be converted to a usable form that can directly power the related sensors or other apparatus and which do not include power storage devices such as batteries.

In an aspect, the method and system for generating electrical power is practiced in well exploration operations where the drill string or drill bit has a rotational action.

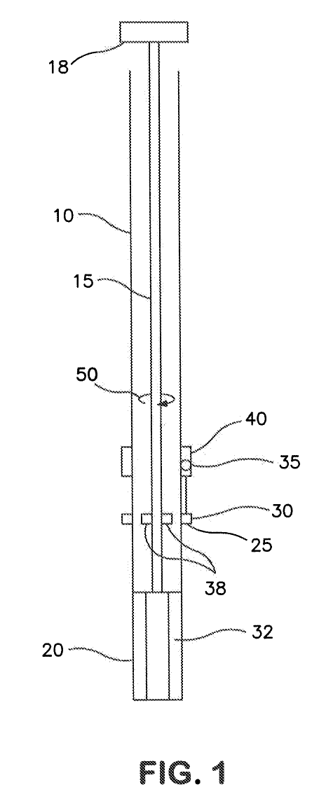

In another embodiment, the method and system for generating electrical power is practiced in a downhole well that contains a progressive cavity pump that is powered by rotating rods. See e.g., FIG. 1. In this embodiment, progressive cavity pumps (PCP) are powered by a continuous rod that is rotated at the surface by a prime mover. A rod transmits that rotational energy to the pump that is located near the bottom of the well. This invention utilizes that rotational motion to generate electrical energy inside the well.

In an aspect, an apparatus of the system is comprised of at least two parts. FIG. 1 is illustrative of one non-limiting embodiment of this invention. As shown in FIG. 1 which shows a cross-sectional view of an embodiment of the invention, down hole. Part 1 is a sub part of the tubing 10 that is deployed with the progressing cavity pump (PCP) stator 20 and contains windings of an electrical conductor 25 and power conditioning circuitry 30. Part 2 is attached to the rod 15/rotor assembly 32, and includes a drive head 18 that rotates the rod and forms a continuous rotating shaft from the surface to the rotor of the PCP. Part 2 contains magnets 38 arranged in a manner to provide a rotating magnetic field in close proximity to Part 1. The rotation 50 of part 2 induces electrical current in part 1. Circuitry 30 contained in Part 1 conditions the electrical current so that it is compatible with battery powered devices or can be used to recharge batteries, such as battery 35. FIG. 1 illustrates that the energy from the rotational generator can be connected to a battery 35 via a wire and then connected to a wireless gauge, e.g. 40, that is capable of transmitting data to the surface.

This inventive method and system would enable the use of wireless gauges, like gauge 40, without the issue of battery life, such as in gauge and sensor components in cableless and wireless telemetry systems. Telemetry can be defined as a communications process by which measurements are made and/or other data collected at remote or inaccessible points, with subsequent transmission to receiving equipment that monitors, displays, records and/or compiles such data. Many types of wireless telemetry systems can be used to couple remote sensing devices such as pressure, temperature, flow, electromagnetic, acoustic and nuclear sensors to equipment that controls the operation of these sensors, and which also converts the output of these sensors into data and parameters of interest.

As discussed, telemetry monitoring systems are also widely used in measurements of drilling parameters and logs to measure properties of the surrounding strata during drilling operations. The telemetry data might be any physical measurement, such as a liquid level, weight, pH, chlorine concentration, temperature, pressure, proximity, etc., and is sensed by a remote telemetry unit (RTU). In a telemetry system, analog or digital metering data is captured at a remote location by a telemetry computer and is then transmitted to a central computer facility via a telecommunication device. In radio telemetry the telecommunication device is a radio modem that transmits the metering data between the telemetry computer and the central computer facility via radio frequency waves, thus eliminating the need for wiring and cable.

A receiver receives messages from each transmitter. Digital electronic telemetry systems are used to send information over a significant distance in the form of an electrical signal which comprises electrical voltage levels corresponding to binary numbers. Binary numbers are typically used in digital telemetry because they are composed entirely of ones and zeroes.

Based on electromagnetic (EM) data transmission technology, a wireless Telemetry System (TS) system transmits low frequency EM waves from a downhole or subsurface location to the surface, or from the surface to downhole or subsurface, using the well's tubing or casing as the transmission medium. The telemetry system can be retrofitted into existing wells using either wireline or coil tubing, or alternatively, may be completion deployed. In an aspect, the Telemetry System (TS) transmits pressure and temperature information and can further include any physical measurement, such as a liquid level, weight, pH, chlorine concentration, temperature, pressure, proximity, etc., and is sensed by a remote telemetry unit (RTU). Optionally, other sensors can also be utilized downhole to collect and transmit drilling or well data.

Telemetry systems normally utilize a transmitter to transmit electromagnetic signals, e.g. from a measured parameter, and a receiver that receives electromagnetic signals from the transmitter. The prior art telemetry systems typically use and program transmitters to transmit messages that are as short as feasible and within the interval between the measurement and transmissions as long as feasible—sometimes thereby missing valuable events and data. These existing prior art systems endeavor to minimize the average current drain in the transmitters, which are typically battery operated.

Without being tied to battery life, the sensors can now provide real-time to near real time data that enables the reservoir engineer to manage the reservoir more effectively and to optimize production. The ability to collect and transmit real-time data enables the early detection of well drilling or production problems and allows more timely corrective and remedial action.

In one embodiment, the Expro Cableless Telemetry System (CaTS™) is used. It is a battery powered, wireless data transmission system that can be used to monitor and control of both new and existing wells. Currently the Expro CaTs system may use up its battery life within a few months or less when data is transmitted several times an hour, such as with an every 15 minute transmission frequency. This invention would allow CaTs and other wireless gauges known to one skilled in the art to perform until to the gauge circuitry failed or until the monitoring was no longer desired.

Although the invention(s) have been described in terms of certain preferred embodiments and certain preferred uses, other embodiments and other uses that are apparent to those of ordinary skill in the art, including embodiments and uses which do not provide all of the features and advantages set forth herein, are also within the scope of the invention(s). For example, in any method or process described herein, the acts or operations of the method/process are not necessarily limited to any particular disclosed sequence. Also, for purposes of contrasting different embodiments or the prior art, certain aspects and advantages of these embodiments are described herein where appropriate. It should be understood that not necessarily all such aspects and advantages need be achieved in any one embodiment. Thus, it should be recognized that certain embodiments may be carried out in a manner that achieves or optimizes one advantage or group of advantages without necessarily achieving other aspects or advantages that may be taught or suggested herein. Accordingly, the scope of the invention(s) is defined by the claims that follow and their obvious modifications and equivalents.

I claim:

1. A method for generating electrical power, comprising:
providing an apparatus that uses or causes a rotational motion during operation;
placing magnets on a portion of the apparatus, and arranging the magnets in a manner capable of providing a magnetic field when the apparatus is in rotational motion;
inducing an electrical current from the magnetic field when the apparatus is in rotational motion;
providing circuitry to capture and condition the electrical current, wherein the electrical current is conditioned to be compatible with the electrically powered device; and
positioning the device that is capable of being electrically powered within a proximity of the apparatus to thereby power the device with the captured and conditioned electrical current.

2. The method of claim 1, wherein the generated electrical power directly powers the device.

3. The method of claim 1, wherein the electrically powered device is a sensor.

4. The method of claim 1, wherein the electrically powered device is a telemetry apparatus.

5. The method of claim 4, wherein the telemetry apparatus is capable of providing sensor readings, and wherein a frequency of a sensor reading can be increased in comparison to telemetry apparatuses that lack an internal power generation.

6. The method of claim 5, wherein the telemetry apparatus is capable of providing sensor readings, and wherein a duration of a transmission from the sensor readings can be increased in comparison to telemetry apparatuses that lack internal power generation.

7. The method of claim 1, wherein the apparatus that uses or causes a rotational motion during operation is a progressive cavity pump that is powered by a continuous rod that is rotated at the surface by a rotation producing mechanism, and wherein the battery powered device is a cableless telemetry apparatus.

8. The method of claim 7, wherein the rotation producing mechanism is an electric or hydraulic motor.

9. A method of generating electrical power to charge a downhole or subsurface tool, comprising of:
providing an apparatus that uses or causes a rotational motion during operation;
placing magnets on a portion of the apparatus, and arranging the magnets in a manner capable of providing a magnetic field when the apparatus is in rotational motion;
providing a device that is capable of being powered by a battery;
inducing an electrical current from the magnetic field when the apparatus is in rotational motion;
providing circuitry to capture and condition the electrical current, wherein the electrical current is conditioned to be compatible with the battery powered device; and
positioning a subsurface device that is capable of being powered by the battery within a proximity of the apparatus to thereby power the device with the captured and conditioned electrical current.

10. The method of claim 9, wherein the generated electrical power directly powers the device and also charges or recharges a battery associated with the device.

11. The method of claim 9, wherein the generated electrical power indirectly powers the device by charging a battery that directly powers the device.

12. The method of claim 9, wherein the electrical power recharges a battery that powers a device.

13. The method of claim 10, wherein the device is a downhole sensor.

14. The method of claim 11, wherein the device is a telemetry system.

15. The method of claim 14, wherein the telemetry system is capable of providing sensor readings, and wherein a frequency of a sensor reading can be increased in comparison to telemetry systems that lack an internal power generation.

16. The method of claim 14, wherein the telemetry system is capable of providing sensor readings, and wherein a duration of a transmission from the sensor readings can be increased in comparison to telemetry systems that lack an internal power generation.

17. The method of claim 14, wherein the apparatus that uses or causes a rotational motion during operation is a progressive cavity pump that is powered by a continuous rod that is rotated at the surface by a rotation producing mechanism, and wherein the battery powered device is a cableless telemetry system.

18. The method of claim 17, wherein the rotation producing mechanism is an electric or hydraulic motor.
